(19) United States
(12) Patent Application Publication
(10) Pub. No.: US 2026/0104613 A1
(43) Pub. Date: Apr. 16, 2026

(54) ELECTRONIC DEVICE

(71) Applicant: InnoLux Corporation, Miao-Li County (TW)

(72) Inventors: Chuan-Chi CHIEN, Miao-Li County (TW); Mei-Chi HSU, Miao-Li County (TW)

(21) Appl. No.: 19/328,877

(22) Filed: Sep. 15, 2025

(30) Foreign Application Priority Data
Oct. 15, 2024 (CN) 202411435561.4

(51) Int. Cl. G02F 1/1347; G02F 1/133; G02F 1/1335

(52) U.S. Cl. CPC G02F 1/13478; G02F 1/13324; G02F 1/133514

(57) ABSTRACT

An electronic device includes a reflective panel and an optical sensing element. The reflective panel includes a first cholesteric liquid crystal for reflecting light of first color, and a first color filter layer disposed under the first cholesteric liquid crystal, wherein the first color filter layer includes a first opening. The optical sensing element is disposed under the reflective panel, wherein, in a top-view direction, the optical sensing element overlaps with the first opening of the first color filter layer.

### CROSS-REFERENCE TO RELATED APPLICATIONS

This application claims the benefits of the Chinese Patent Application Serial Number 202411435561.4, filed on Oct. 15, 2024, the subject matter of which is incorporated herein by reference.

### BACKGROUND

### Field of the Disclosure

The present disclosure relates to an electronic device and, more particularly, to an electronic device having a reflective panel and an optical sensing element.

### Description of Related Art

Reflective electronic devices (displays) have been in wide spread use in life. If a bi-stable cholesteric liquid crystal panel is used, its power consumption may be greatly reduced, which is beneficial to environmental protection and other advantages.

When a reflective electronic device is used in conjunction with an optical sensing element, the non-light-transmitting layer in the reflective electronic device may cause an influence to the optical sensing element, resulting in poor performance of the optical sensing element.

Therefore, there is a need to provide an electronic device to alleviate and/or obviate the aforementioned defects.

### SUMMARY

The present disclosure provides an electronic device, which is characterized in comprising: a reflective panel including a first cholesteric liquid crystal for reflecting light of first color; and a first color filter layer disposed under the first cholesteric liquid crystal, wherein the first color filter layer includes a first opening; and an optical sensing element disposed under the reflective panel, wherein, in a top-view direction, the optical sensing element overlaps with the first opening of the first color filter layer.

The present disclosure further provides an electronic device, which is characterized in comprising: a reflective panel; an optical sensing element disposed under the reflective panel; and a light absorbing layer disposed between the reflective panel and the optical sensing element, wherein, in a top-view direction, the light absorbing layer overlaps with the optical sensing element, wherein the optical sensing element is provided to sense light of first wavelength, and a transmittance of the light absorbing layer to the light of first wavelength is greater than or equal to 50%.

Other novel features of the disclosure will become more apparent from the following detailed description when taken in conjunction with the accompanying drawings.

### BRIEF DESCRIPTION OF DRAWINGS

FIG. 1A is a schematic cross-sectional view of an electronic device according to an embodiment of the present disclosure;

FIG. 1B is a partial enlarged view of FIG. 1A;

FIG. 2A is a schematic top view of an electronic device according to an embodiment of the present disclosure;

FIG. 2B is a schematic cross-sectional view of the electronic device taken along line A-A′ of FIG. 2A;

FIG. 2C and FIG. 2D are partial enlarged views of FIG. 2A;

FIG. 3A is a schematic cross-sectional view of an electronic device according to an embodiment of the present disclosure;

FIG. 3B is a partial enlarged view of FIG. 3A;

FIG. 4A is a schematic top view of an electronic device according to an embodiment of the present disclosure;

FIG. 4B is a schematic cross-sectional view of the electronic device taken along line D-D′ of FIG. 4A;

FIG. 4C is a partial enlarged view of FIG. 4A;

FIG. 5 is a schematic cross-sectional view of an electronic device according to an embodiment of the present disclosure;

FIG. 6 is a schematic cross-sectional view of an electronic device according to an embodiment of the present disclosure;

FIG. 7 is a schematic cross-sectional view of an electronic device according to an embodiment of the present disclosure;

FIG. 8 is a schematic cross-sectional view of an electronic device according to an embodiment of the present disclosure;

FIG. 9 is a schematic cross-sectional view of an electronic device according to an embodiment of the present disclosure;

FIG. 10 is a schematic cross-sectional view of an electronic device according to an embodiment of the present disclosure;

FIG. 11A is a schematic cross-sectional view of an electronic device according to an embodiment of the present disclosure;

FIG. 11B is a partial enlarged view of the first panel;

FIG. 11C is a partial enlarged view of FIG. 11A; and

FIG. 12 is a schematic cross-sectional view of an electronic device according to an embodiment of the present disclosure.

### DETAILED DESCRIPTION OF EMBODIMENT

The electronic device according to the embodiment of the present disclosure is described in detail below. It should be understood that the following description provides many different embodiments for implementing different aspects of some embodiments of the present disclosure. The specific components and arrangements described below are only for the purpose of simply and clearly describing some embodiments of the present disclosure. Of course, these are only examples and are not limitations of the present disclosure. In addition, similar and/or corresponding reference numerals may be used in different embodiments to identify similar and/or corresponding components in order to clearly describe the present disclosure. However, the use of these similar and/or corresponding reference numerals is only for simply and clearly describing some embodiments of the present disclosure, and does not represent any relationship between the different embodiments and/or structures discussed.

The embodiments of the present disclosure may be understood together with the drawings, and the drawings of the present disclosure are also regarded as part of the disclosure description. It should be understood that the drawings of the present disclosure are not in scale and, in fact, the dimensions of elements may be arbitrarily enlarged or reduced in order to clearly illustrate features of the present disclosure. In addition, directional terms mentioned in the specification, such as “up”, “down”, “front”, “rear”, “left”, “right”, etc., only refer to the directions of the drawings. Accordingly, the directional term used is illustrative, not limiting, of the present disclosure. In the drawings, various figures illustrate the general characteristics of methods, structures and/or materials used in particular embodiments. However, these drawings should not be construed to define or limit the scope or nature encompassed by these embodiments. For example, the relative sizes, thicknesses and positions of various layers, regions and/or structures may be reduced or enlarged for clarity.

One structure (or layer, component, substrate) described in the present disclosure is disposed on/above another structure (or layer, component, substrate), which can mean that the two structures are adjacent and directly connected, or can refer to two structures that are adjacent rather than directly connected. Indirect connection means that there is at least one intermediate structure (or intermediate layer, intermediate component, intermediate substrate, intermediate space) between the two structures, the lower surface of one structure is adjacent to or directly connected to the upper surface of the intermediate structure, and the upper surface of the other structure is adjacent to or directly connected to the lower surface of the intermediate structure. The intermediate structure may be a single-layer or multi-layer physical structure or a non-physical structure, which is not limited. In the present disclosure, when a certain structure is arranged “on” other structures, it may mean that a certain structure is “directly” on other structures, or it means that a certain structure is “indirectly” on other structures; that is, at least one structure is sandwiched, in between a certain structure and other structures.

In addition, it should be understood that, unless otherwise specified, the ordinal numbers used in the specification and claims, such as “first” and “second”, are intended to distinguish elements rather than disclose explicitly or implicitly that names of the elements bear the wording of the ordinal numbers. The ordinal numbers do not imply what order an element and another element are in terms of space, time or steps of a manufacturing method. Thus, what is referred to as a “first element” in the specification may be referred to as a “second element” in the claims.

In some embodiments of the present disclosure, terms such as “connection” and “interconnection” about joining and connecting, unless otherwise specified, may mean that two structures are in direct contact, or may also mean that two structures are not in direct contact, where other structures are placed between the two structures. Moreover, the terms about joining and connecting may also include the situation that both structures are movable, or both structures are fixed. In addition, the term “electrical connection” or “coupling” includes any direct and indirect means of electrical connection.

In the description, the terms “almost”, “about”, “approximately” or “substantially” usually means within 10%, 5%, 3%, 2%, 1% or 0.5% of a given value or range. Unless otherwise defined, the term “range between the first value and the second value” indicates that the range includes the first value, the second value, and other values in between. Moreover, any two values or directions used for comparison may have certain errors. If the first value is equal to the second value, it implies that there may be an error of about 10% between the first value and the second value; if the first direction is perpendicular or “approximately” perpendicular to the second direction, the angle between the first direction and the second direction may be between 80 degrees and 100 degrees; if the first direction is parallel or “substantially” parallel to the second direction, the angle between the first direction and the second direction may be between 0 degrees and 10 degrees. In the present disclosure, the expressions “the given range is from the first value to the second value” and “the given range falls within the range from the first value to the second value” indicate that the given range includes the first value, the second value, and other values in between.

Furthermore, according to the embodiments of the present disclosure, an optical microscope (OM), a scanning electron microscope (SEM), an thin film thickness profiler (α-step), an ellipsometer, or other suitable methods may be used to measure the thickness, length, width of each component or the distance and angle between components. In detail, according to some embodiments, a scanning electron microscope may be used to obtain a cross-sectional image of a structure and measure the thickness, length, width of each component or the distance and angle between components.

In the entire specification and appended claims of the present disclosure, certain words are used to refer to specific components. Those skilled in the art should understand that electronic device manufacturers may refer to the same components by different names. The present disclosure does not intend to distinguish those components with the same function but different names. In the following description and claims, words such as “comprising”, “including”, and “having” are open type words, so they should be interpreted as meaning “including but not limited to”. Therefore, when the terms “comprising”, “including” and/or “having” are used in the description of the present disclosure, they specify the existence of corresponding features, regions, steps, operations and/or components, but do not exclude the existence of one or more corresponding features, regions, steps, operations and/or components.

It should be understood that, without departing from the spirit of the present disclosure, in the following embodiments, the features in different embodiments may be replaced, reorganized or mixed to accomplish other embodiments. The features among various embodiments may be mixed and matched arbitrarily as long as they do not violate the spirit of the invention or conflict with each other.

Unless otherwise defined, all terms (including technical and scientific terms) used herein have the same meaning as commonly understood by one of ordinary skill in the art to which this disclosure belongs. It may be understood that these terms, such as those defined in commonly used dictionaries, should be interpreted as having meanings consistent with the background or context of the related technology and the present disclosure, and should not be interpreted in an idealized or overly formal manner, unless otherwise specified in the embodiments of the present disclosure. The present disclosure may be understood by referring to the following detailed description in conjunction with the accompanying drawings. It should be noted that, in order to facilitate the understanding of the readers and for the simplicity of the drawings, the multiple drawings in the present disclosure only depict a portion of the electronic device, and the specific components in the drawings are not drawn according to the actual scale. In addition, the number and size of each component in the figure are only for illustration and are not intended to limit the scope of the present disclosure.

The electronic device of the present disclosure may include electronic components. Electronic components may include passive components, active components, or a combination thereof, such as capacitors, resistors, inductors, varactors, variable capacitors, filters, diodes, transistors, sensors, micro-electromechanical system components (MEMS), liquid crystal chips, etc., but not limited thereto. The diodes may include light emitting diodes or non-light emitting diodes. The diode includes a P-N junction diode, a PIN diode or a constant current diode. The light emitting diode may include, for example, an organic light emitting diode (OLED), a mini LED, a micro LED, a quantum dot LED, fluorescence, phosphor or other suitable materials, or a combination thereof, but not limited thereto. The sensor may include, for example, a capacitive sensor, an optical sensor, an electromagnetic sensor, a fingerprint sensor (FPS), a touch sensor, an antenna, or a pen sensor, but not limited thereto. The following description will use a display device as an electronic device to illustrate the present disclosure, but not limited thereto.

The electronic device may include an imaging device, a bonding device, a display device, a backlight device, an antenna device, a tiled device, a touch display, a curved display, or a free shape display, but not limited thereto. The electronic device may include, for example, liquid crystal, light emitting diode, fluorescence, phosphor, other suitable display media, or a combination thereof, but not limited thereto. The display device may be a non-self-luminous display device or a self-luminous display device. The antenna device may be a liquid crystal type antenna device or a non-liquid crystal type antenna device, and the sensing device may be a sensing device that senses capacitance, light, heat energy, or ultrasound, but not limited thereto. The tiled device may be, for example, a display tiled device or an antenna tiled device, but not limited thereto. It should be noted that the electronic device may be any arrangement or combination of the aforementioned, but not limited thereto. The electronic device may be a bendable or flexible electronic device. It should be noted that the electronic device may be any arrangement or combination of the aforementioned, but not limited thereto. In addition, the shape of the electronic device may be rectangular, circular, polygonal, a shape with curved edges, or other suitable shapes. The electronic device may have a peripheral system such as a driving system, a control system, a light source system, a shelf system, etc. to support a display device, an antenna device, or a tiled device. It should be noted that the following embodiments may be implemented by replacing, reorganizing, or mixing features of several different embodiments without departing from the spirit of the present disclosure to implement other embodiments. The features of the various embodiments may be mixed and matched as desired as long as they do not violate the spirit of the disclosure or conflict with each other. It should be noted that the technical solutions provided in the following different embodiments may be replaced, combined or mixed with each other to form another embodiment without violating the spirit of the present disclosure.

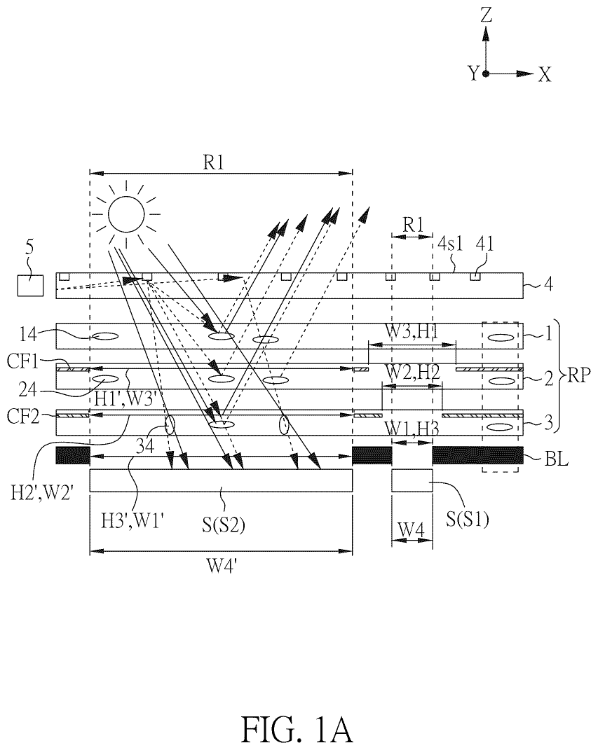

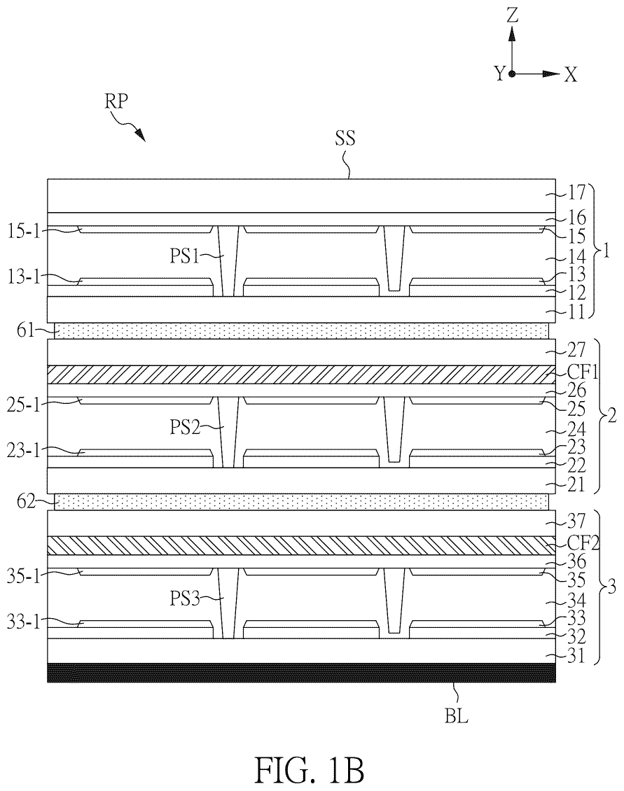

FIG. 1A is a schematic cross-sectional view of an electronic device according to an embodiment of the present disclosure, and FIG. 1B is a partial enlarged view of FIG. 1A, wherein, for the convenience of explanation, some components are omitted in the figures.

In one embodiment of the present disclosure, as shown in FIG. 1A, the electronic device may include: a reflective panel RP including a first cholesteric liquid crystal 14 for reflecting light of first color, and a first color filter layer CF1 arranged under the first cholesteric liquid crystal 14, wherein the first color filter layer CF1 includes a first opening H1 (or a first opening H1′); and an optical sensing element S arranged under the reflective panel RP, wherein, in a top-view direction Z, the optical sensing element S overlaps with the first opening H1 (or the first opening H1′) of the first color filter layer CF1. When the electronic device includes a plurality of optical sensing elements S, the first color filter layer CF1 may include a plurality of first openings H1, H1′, wherein the plurality of optical sensing elements S may overlap with the first openings H1, H1′ of the first color filter layer CF1, respectively.

In one embodiment of the present disclosure, as shown in FIG. 1A, the reflective panel RP may further include: a second cholesteric liquid crystal 24 arranged under the first color filter layer CF1, wherein the second cholesteric liquid crystal 24 is used to reflect a light of second color; a second color filter layer CF2 arranged under the second cholesteric liquid crystal 24, wherein the second color filter layer CF2 includes a second opening H2 (or a second opening H2′); a third cholesteric liquid crystal 34 arranged under the second color filter layer CF2, wherein the third cholesteric liquid crystal 34 is used to reflect light of third color. In the top-view direction Z, the optical sensing element S overlaps with the second opening H2 (or the second opening H2′) of the second color filter layer CF2. When the electronic device includes a plurality of optical sensing elements S, the second color filter layer CF2 may include a plurality of second openings H2, H2′, wherein the plurality of optical sensing elements S may overlap with the second openings H2, H2′ of the second color filter layer CF2, respectively.

The present disclosure reduces the influence of the non-light-transmitting layer (color filter layer) on the optical sensing element S by partially overlapping the opening of the color filter layer with the optical sensing element S. When the optical sensing element S is a camera lens, the image quality of the camera lens may be improved. When the optical sensing element S is a photoelectric conversion element, the light conversion efficiency may be improved. When the optical sensing element S is a biometric sensing element, the sensing effect may be improved. The electronic device of the present disclosure may be applied to an electronic device having an optical sensing element S, but the present disclosure is not limited thereto.

In one embodiment of the present disclosure, the reflective panel RP may include three sub-panels (for example, a first panel 1, a second panel 2 and a third panel 3), and the first cholesteric liquid crystal 14, the second cholesteric liquid crystal 24 and the third cholesteric liquid crystal 34 are disposed in the three sub-panels, respectively. In more detail, as shown in FIG. 1B, the first panel 1 may include: a first substrate 11; a second substrate 17 arranged relative to the first substrate 11; a first cholesteric liquid crystal 14 arranged between the first substrate 11 and the second substrate 17; a first electrode layer 13 (including a plurality of first electrodes 13-1) arranged between the first substrate 11 and the first cholesteric liquid crystal 14; and a second electrode layer 15 (including a plurality of second electrodes 15-1) arranged between the second substrate 17 and the first cholesteric liquid crystal 14. The second panel 2 may include: a third substrate 21; a fourth substrate 27 arranged relative to the third substrate 21; a second cholesteric liquid crystal 24 arranged between the third substrate 21 and the fourth substrate 27; a third electrode layer 23 (including a plurality of third electrodes 23-1) arranged between the third substrate 21 and the second cholesteric liquid crystal 24; a fourth electrode layer 25 (including a plurality of fourth electrodes 25-1) arranged between the fourth substrate 27 and the second cholesteric liquid crystal 24; and a first color filter layer CF1 arranged between the fourth substrate 27 and the fourth electrode layer 25, but not limited thereto, wherein the first color filter layer CF1 is, for example, arranged under the first cholesteric liquid crystal 14, that is, the first color filter layer CF1 is farther away from the display surface SS than the first cholesteric liquid crystal 14. The third panel 3 may include: a fifth substrate 31; a sixth substrate 37 arranged relative to the fifth substrate 31; a third cholesteric liquid crystal 34 arranged between the fifth substrate 31 and the sixth substrate 37; a fifth electrode layer 33 (including a plurality of fifth electrodes 33-1) arranged between the fifth substrate 31 and the third cholesteric liquid crystal 34; a sixth electrode layer 35 (including a plurality of sixth electrodes 35-1) arranged between the sixth substrate 37 and the third cholesteric liquid crystal 34; and a second color filter layer CF2 arranged between the sixth substrate 37 and the sixth electrode layer 35, but not limited thereto, wherein the second color filter layer CF2 is, for example, arranged under the second cholesteric liquid crystal 24, that is, the second color filter layer CF2 is farther away from the display surface SS than the second cholesteric liquid crystal 24. The first cholesteric liquid crystal 14 may be controlled by applying voltage to the first electrode layer 13 (first electrodes 13-1) and the second electrode layer 15 (second electrodes 15-1) to generate an electric field, the second cholesteric liquid crystal 24 may be controlled by applying voltage to the third electrode layer 23 (third electrodes 23-1) and the fourth electrode layer 25 (fourth electrodes 25-1) to generate an electric field, and the third cholesteric liquid crystal 34 may be controlled by applying voltage to the fifth electrode layer 333 (fifth electrodes 33-1) and the sixth electrode layer 35 (sixth electrodes 35-1) to generate an electric field, so that the first cholesteric liquid crystal 14, the second cholesteric liquid crystal 24 and the third cholesteric liquid crystal 34 are switched in different states (for example, a transmissive state and a reflective state, but not limited thereto), with which the electronic device may display image. In more detail, when the first cholesteric liquid crystal 14, the second cholesteric liquid crystal 24 and the third cholesteric liquid crystal 34 are switched to the transmissive state, most of the incident light may pass through the reflective panel RP to reach the optical sensing element S or cause the electronic device to display a dark state; when the first cholesteric liquid crystal 14, the second cholesteric liquid crystal 24 and/or the third cholesteric liquid crystal 34 are selectively switched to the reflective state, part of the incident light may be reflected by the first cholesteric liquid crystal 14, the second cholesteric liquid crystal 24 and/or the third cholesteric liquid crystal 34, thereby displaying an image.

In one embodiment of the present disclosure, as shown in FIG. 1A and FIG. 1B, the electronic device may include a light absorbing layer BL disposed between the reflective panel RP and the optical sensing element S, and the light absorbing layer BL includes a third opening H3 (or a third opening H3′), wherein, in the top-view direction Z, the optical sensing element S overlaps with the third opening H3 (or the third opening H3′) of the light absorbing layer BL. The light absorbing layer BL may be used to absorb most of the light that is not reflected by the first cholesteric liquid crystal 14, the second cholesteric liquid crystal 24 and the third cholesteric liquid crystal 34, thereby improving the display quality of the electronic device. When the electronic device includes a plurality of optical sensing elements S, the light absorbing layer BL may include a plurality of third openings H3, H3′, wherein the plurality of optical sensing elements S may overlap with the third openings H3, H3′ of the light absorbing layer BL, respectively.

In the present disclosure, the first substrate 11, the second substrate 17, the third substrate 21, the fourth substrate 27, the fifth substrate 31 and the sixth substrate 37 may each include a rigid substrate or a flexible substrate. The materials of the first substrate 11, the second substrate 17, the third substrate 21, the fourth substrate 27, the fifth substrate 31 and the sixth substrate 37 may each include glass, quartz, sapphire, ceramic, plastic, polycarbonate (PC), polyimide (PI), polypropylene (PP), polyethylene terephthalate (PET), polymethylmethacrylate (PMMA), other suitable materials or a combination thereof, but the present disclosure is not limited thereto. When the first substrate 11, the second substrate 17, the third substrate 21, the fourth substrate 27, the fifth substrate 31 and the sixth substrate 37 are flexible substrates, the electronic device of the present disclosure may be a flexible display device.

In the present disclosure, the materials of the first electrode layer 13, the second electrode layer 15, the third electrode layer 23, the fourth electrode layer 25, the fifth electrode layer 33 and the sixth electrode layer 35 may each include a transparent conductive material, such as indium zinc oxide (IZO), indium tin oxide (ITO), indium tin zinc oxide (ITZO), indium gallium zinc oxide (IGZO), aluminum zinc oxide (AZO) or a combination thereof, but the present disclosure is not limited thereto.

In one embodiment of the present disclosure, the first cholesteric liquid crystal 14 is, for example, a cholesteric liquid crystal capable of reflecting blue light, the second cholesteric liquid crystal 24 is, for example, a cholesteric liquid crystal capable of reflecting green light, and the third cholesteric liquid crystal 34 is, for example, a cholesteric liquid crystal capable of reflecting red light, but the present disclosure is not limited thereto. The aforementioned cholesteric liquid crystals may reflect light of different colors according to the design.

In the present disclosure, the materials of the first color filter layer CF1 and the second color filter layer CF2 may be the same or different, wherein suitable materials include photoresist materials, but the present disclosure is not limited thereto. In one embodiment of the present disclosure, the first color filter layer CF1 and the second color filter layer CF2 are photoresists of different colors, for example, the first color filter layer CF1 is a yellow filter layer, and the second color filter layer CF2 is a red filter layer, but it is not limited thereto. By disposing the first color filter layer CF1 and the second color filter layer CF2, the color purity or brilliance displayed by the electronic device may be improved. In the present disclosure, in a cross section, the width W3 of the first opening H1 of the first color filter layer CF1 may be, for example, greater than or equal to 15 mm. For example, the width W3 of the first opening H1 may be greater than or equal to 15 mm and smaller than or equal to 50 mm, greater than or equal to 15 mm and smaller than or equal to 40 mm, or greater than or equal to 15 mm and smaller than or equal to 30 mm, but the present disclosure is not limited thereto. The width W2 of the second opening H2 of the second color filter layer CF2 may be, for example, greater than or equal to 10 mm. For example, the width W2 of the second opening H2 may be greater than or equal to 10 mm and smaller than or equal to 30 mm, greater than or equal to 10 mm and smaller than or equal to 20 mm, or greater than or equal to 15 mm and smaller than or equal to 30 mm, but the present disclosure is not limited thereto. In the present disclosure, the width W3′ of the first opening H1′ of the first color filter layer CF1 may be greater than or equal to 15 mm. For example, the width W3′ of the first opening H1′ may be greater than or equal to 15 mm and smaller than or equal to 50 mm, greater than or equal to 15 mm and smaller than or equal to 40 mm, or greater than or equal to 15 mm and smaller than or equal to 30 mm, but the present disclosure is not limited thereto. The width W2′ of the second opening H2′ of the second color filter layer CF2 may be, for example, greater than or equal to 10 mm. For example, the width W2′ of the second opening H2′ may be greater than or equal to 10 mm and smaller than or equal to 40 mm, greater than or equal to 10 mm and smaller than or equal to 30 mm, or greater than or equal to 15 mm and smaller than or equal to 30 mm, but the present disclosure is not limited thereto. The “width of the opening” refers to, for example, the maximum dimension of the opening in a direction (for example, X direction). In one embodiment of the present disclosure, the width W2 of the second opening H2 may be smaller than or equal to the width W3 of the first opening H1, so as to reduce the alignment error or improve the process yield. In one embodiment of the present disclosure, the width W2′ of the second opening H2′ may be smaller than or equal to the width W3′ of the first opening H1′, which may reduce the alignment error or improve the process yield.

In the present disclosure, the material of the light absorbing layer BL may include a black insulating layer, such as a black organic material, a black inorganic material, a black ink, other suitable materials or a combination thereof, but the present disclosure is not limited thereto. In the present disclosure, the width W1 of the third opening H3 of the light absorbing layer BL may be greater than or equal to 5 mm, for example, the width W1 of the third opening H3 may be greater than or equal to 5 mm and smaller than or equal to 20 mm, greater than or equal to 5 mm and smaller than or equal to 15 mm, or greater than or equal to 5 mm and smaller than or equal to 10 mm, but the present disclosure is not limited thereto. In the present disclosure, the width W1′ of the third opening H3′ of the light absorbing layer BL may be greater than or equal to 5 mm, for example, the width W1′ of the third opening H3′ may be greater than or equal to 5 mm and smaller than or equal to 20 mm, greater than or equal to 5 mm and smaller than or equal to 15 mm, or greater than or equal to 5 mm and smaller than or equal to 10 mm, but the present disclosure is not limited thereto. The “width of the opening” refers to, for example, the maximum dimension of the opening in a direction (for example, X direction). In one embodiment of the present disclosure, the width W1 of the third opening H3 may be smaller than or equal to the width W2 of the second opening H2, which may reduce alignment error or improve process yield. In one embodiment of the present disclosure, the width W1′ of the third opening H3′ may be smaller than or equal to the width W2′ of the second opening H2′, which may reduce the alignment error or improve the process yield.

In the present disclosure, the optical sensing element S may include, for example, a camera lens, a photoelectric conversion element, a biometric sensing element, or a combination thereof, but the present disclosure is not limited thereto. The photoelectric conversion element may include a solar cell, such as a perovskite solar cell, a dye-sensitized solar cell or other suitable cells or a combination thereof, but the present disclosure is not limited thereto. The perovskite solar cell may, for example, include a perovskite solar cell with an n-i-p structure or a perovskite solar cell with a p-i-n structure, but the present disclosure is not limited thereto. The biometric sensing element may include, for example, a touch sensor, a fingerprint sensor, an infrared sensor, a temperature sensor, other suitable sensors, or a combination thereof, but the present disclosure is not limited thereto. In one embodiment of the present disclosure, the width W4 of the optical sensing element S (for example, the optical sensing element S1) may be, for example, greater than or equal to 5 mm and smaller than or equal to 20 mm, greater than or equal to 5 mm and smaller than or equal to 15 mm, or greater than or equal to 5 mm and smaller than or equal to 10 mm, but the present disclosure is not limited thereto. In one embodiment of the present disclosure, the width W4′ of the optical sensing element S (for example, the optical sensing element S2) may be, for example, greater than or equal to 5 mm and smaller than or equal to 20 mm, greater than or equal to 5 mm and smaller than or equal to 15 mm, or greater than or equal to 5 mm and smaller than or equal to 10 mm, but the present disclosure is not limited thereto. The “width of the optical sensing element” refers to, for example, the maximum dimension of a hole module in the optical sensing element S through which light is allowed to pass in one direction (for example, X direction). In one embodiment of the present disclosure, the width W4 of the optical sensing element S may be smaller than or equal to the width W1 of the third opening H3, which may reduce the alignment error or improve the process yield. In one embodiment of the present disclosure, the width W4′ of the optical sensing element S may be smaller than or equal to the width W1′ of the third opening H3′, which may reduce the alignment error or improve the process yield. In one embodiment of the present disclosure, as shown in FIG. 1A, the electronic device may include a plurality of optical sensing elements S1 and S2. The optical sensing element S1 may be different from the optical sensing element S2. The optical sensing element S1 may be a camera lens, and the optical sensing element S2 may be a photoelectric conversion element, but the present disclosure is not limited thereto. In the top-view direction Z, the size of the optical sensing element S2 is, for example, greater than that of the optical sensing element S1. The optical sensing element S1 is, for example, spaced apart from the optical sensing element S2 by a distance, that is, the optical sensing element S1 and the optical sensing element S2 do not overlap.

In one embodiment of the present disclosure, as shown in FIG. 1A, the reflective panel RP has an optical sensing element area R1. In the top-view direction Z, the optical sensing element area R1 overlaps with the optical sensing element S. When the optical sensing element S is activated, the first cholesteric liquid crystal 14, the second cholesteric liquid crystal 24 and/or the third cholesteric liquid crystal 34 disposed in the optical sensing element area R1 may be selectively switched to the transmissive state according to the area size or type of the optical sensing element area R1, but it is not limited thereto. When the optical sensing element S1 is a camera lens, for example, the first cholesteric liquid crystal 14, the second cholesteric liquid crystal 24 and/or the third cholesteric liquid crystal 34 of the optical sensing element area R1 overlapping with the optical sensing element S1 may be switched to a transmissive state to reduce the camera lens from being disturbed by the cholesteric liquid crystal and affecting the camera quality, but it is not limited thereto. For example, when the optical sensing element S2 is a photoelectric conversion element, the first cholesteric liquid crystal 14, the second cholesteric liquid crystal 24 and/or the third cholesteric liquid crystal 34 of the optical sensing element area R1 overlapping with the optical sensing element S2 may be selectively partially switched to a transmissive state, so that more light may pass through the reflective panel RP to the optical sensing element S2, thereby converting light into electrical energy, but it is not limited thereto. When the first cholesteric liquid crystal 14, the second cholesteric liquid crystal 24 and/or the third cholesteric liquid crystal 34 are switched to the reflective state, part of the light may still pass through the reflective panel RP to the optical sensing element S2. For example, when the optical sensing element S is a biosensor, the first cholesteric liquid crystal 14, the second cholesteric liquid crystal 24 and/or the third cholesteric liquid crystal 34 in the optical sensing element area R1 may be switched to a transmissive state to reduce the sensing effect of the biosensor being disturbed by the cholesteric liquid crystal, but it is not limited thereto.

In one embodiment of the present disclosure, as shown in FIG. 1A, the electronic device may further include a light guide plate 4 disposed on the reflective panel RP; and a light source 5 disposed adjacent to at least one side of the light guide plate 4. When the electronic device is in a darker environment, the light source 5 may provide additional light and guide most of the emitted light downward to the reflective panel RP through the light guide plate 4 so as to improve the display quality of the electronic device. In the present disclosure, the material of the light guide plate 4 may include glass, polycarbonate (PC), polymethylmethacrylate (PMMA), polyethylene terephthalate (PET), a suitable high light transmittance material or a combination thereof, but the present disclosure is not limited thereto. The light guide plate 4 may selectively include a plurality of microstructures 41 disposed on a light emitting surface 4s1 of the light guide plate 4 away from the reflective panel RP, but it is not limited thereto. The microstructure 41 mayn be used to improve the utilization efficiency of light. The microstructure 41 may include a concave structure, a convex structure or a combination thereof. At the same unit area, the density of the microstructures 41 near the light source 5 may be smaller than the density of the microstructures 41 far from the light source 5. In the present disclosure, the light source 5 may include a light emitting diode (LED), which may include, for example, an organic light emitting diode (OLED), a sub-millimeter light emitting diode (mini LED), a micro LED or a quantum dot light emitting diode (which may include QLED, QDLED), fluorescence, phosphor, other suitable materials or a combination thereof, but the present disclosure is not limited thereto.

In one embodiment of the present disclosure, as shown in FIG. 1B, the first panel 1 may further include: a first insulating layer 12 disposed between the first substrate 11 and the first electrode layer 13; a first planarization layer 16 disposed between the second substrate 17 and the second electrode layer 15; and a first spacer PS1 disposed between the first substrate 11 and the second substrate 17. The second panel 2 may further include: a second insulating layer 22 disposed between the third substrate 21 and the third electrode layer 23; and a second planarization layer 26 disposed between the fourth substrate 27 and the fourth electrode layer 25, wherein the first color filter layer CF1 may be disposed, for example, between the first cholesteric liquid crystal 14 and the second cholesteric liquid crystal 24 and/or between the fourth substrate 27 and the second planarization layer 26; and a second spacer PS2 disposed between the third substrate 21 and the fourth substrate 27. The third panel 3 may further include: a third insulating layer 32 disposed between the fifth substrate 31 and the fifth electrode layer 33; a third planarization layer 36 disposed between the sixth substrate 37 and the sixth electrode layer 35, wherein the second color filter layer CF2 may be disposed, for example, between the second cholesteric liquid crystal 24 and the third cholesteric liquid crystal 34, and/or the second color filter layer CF2 may be disposed between the sixth substrate 37 and the third planarization layer 36; and a third spacer PS3 disposed between the fifth substrate 31 and the sixth substrate 37.

In the present disclosure, the materials of the first insulating layer 12, the second insulating layer 22, the third insulating layer 32, the first planarization layer 16, the second planarization layer 26 and the third planarization layer 36 may each include silicon nitride, silicon oxide, silicon oxynitride, silicon carbonitride, aluminum oxide, organic materials or a combination thereof, but the present disclosure is not limited thereto, wherein suitable organic materials include acrylic acid, polyimide, benzocyclobutene-based resin, acrylate-based resin, or a combination thereof, but the present disclosure is not limited thereto. In one embodiment of the present disclosure, the first planarization layer 16 may selectively have an anti-UV effect, for example, the transmittance of UV light may be smaller than 50%, but the present disclosure is not limited thereto. In this way, the damage of the liquid crystal material in the reflective panel RP caused by UV light may be reduced. In the present disclosure, the materials of the first spacer PS1, the second spacer PS2 and/or the third spacer PS3 may each include resin, organic material, other suitable materials or a combination thereof, but the present disclosure is not limited thereto. In the present disclosure, the cross-sectional shapes of the first spacer SP1, the second spacer SP2 and the third spacer SP3 are not particularly limited. In a cross-section, for example, they may each be a cylinder, a rectangular cylinder, a trapezoidal cylinder, a triangular cylinder, a cone, a triangular pyramid or other irregular cylinders, but the present disclosure is not limited thereto.

In one embodiment of the present disclosure, as shown in FIG. 1B, the reflective panel RP may further include a first adhesive layer 61 disposed between the first panel 1 and the second panel 2; and a second adhesive layer 62 disposed between the second panel 2 and the third panel 3. The first adhesive layer 61 may be used to fix the first panel 1 and the second panel 2 to each other, and the second adhesive layer 62 may be used to fix the second panel 2 and the third panel 3 to each other. In the present disclosure, the materials of the first adhesive layer 61 and the second adhesive layer 62 may each include glass glue, optical glue, silicone glue, tape, hot melt glue, AB glue, two-component adhesive, polymer glue or a combination thereof, but the present disclosure is not limited thereto.

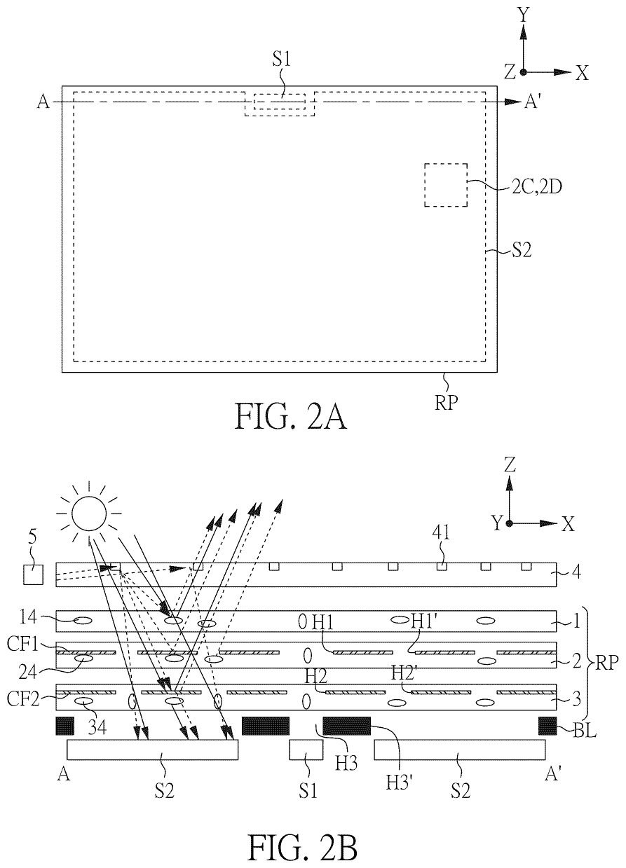

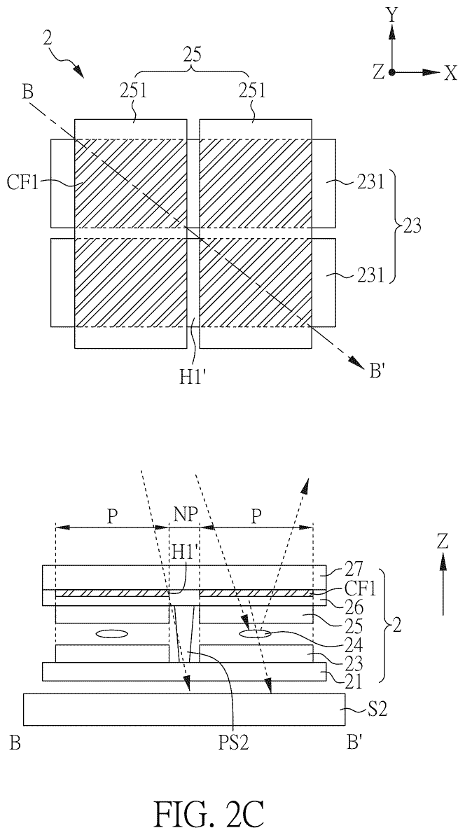

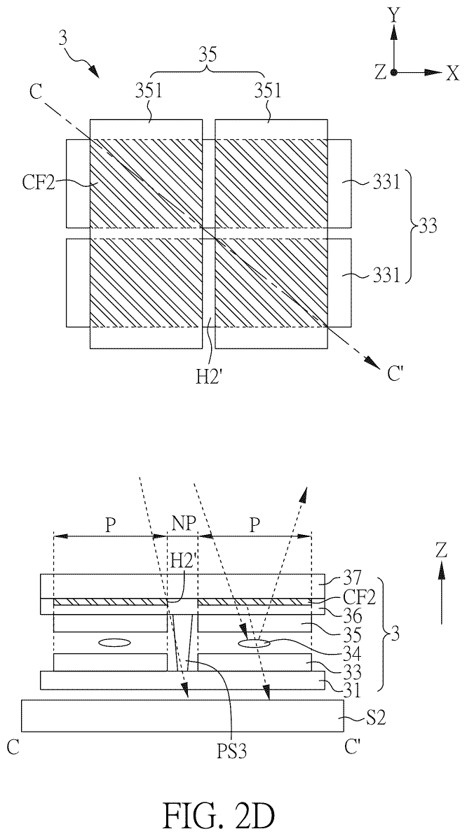

FIG. 2A is a schematic top view of an electronic device according to an embodiment of the present disclosure. FIG. 2B is a schematic cross-sectional view of the electronic device taken along line A-A′ of FIG. 2A. FIG. 2C and FIG. 2D are partial enlarged views of FIG. 2A. The electronic device shown in FIG. 2B is similar to that shown in FIG. 1A, except for the following differences. In addition, some components are omitted in the figures for convenience of explanation.

In one embodiment of the present disclosure, as shown in FIG. 2A and FIG. 2B, the electronic device may include a plurality of optical sensing elements S1 and/or S2 disposed under the reflective panel RP. The optical sensing element S2 may surround a plurality of sides of the optical sensing element S1, but it is not limited thereto. In one embodiment of the present disclosure, the optical sensing element S1 may be, for example, a camera lens, and the optical sensing element S2 may be, for example, a photolectric element, but it is not limited thereto. In the top-view direction Z, the first color filter layer CF1 and/or the second color filter layer CF2 may not overlap with the optical sensing element S1 (for example, a camera lens), thereby improving the image quality. When the width of the optical sensing element S2 is designed to be greater (for example, greater than 20 mm, but not limited thereto), in the top-view direction Z, part of the first color filter layer CF1 may overlap with the optical sensing element S2, and part of the second color filter layer CF2 may overlap with the optical sensing element S2, thereby maintaining display quality and improving light conversion efficiency. In more detail, part of the ambient light and the light provided by the light source may pass through the first color filter layer CF1 and/or the second color filter layer CF2 respectively for being reflected by the cholesteric liquid crystal, thereby improving the color purity or brilliance displayed by the electronic device, and part of the ambient light and the light provided by the light source may pass through the first opening H1′ of the first color filter layer CF1 and the second opening H2′ of the second color filter layer CF2 respectively, so that most of the light may pass through the reflective panel RP to the optical sensing element S2 (for example, a photoelectric conversion element) for being converted into electrical energy.

In one embodiment of the present disclosure, the partial enlarged view of FIG. 2A may be shown, for example, in FIG. 2C. In more detail, the partial enlarged view of the second panel 2 of the reflective panel RP may be shown, for example, in FIG. 2C. The upper half of FIG. 2C is a top view, and the lower half is a cross-sectional view taken along line B-B′ of the upper half. The third electrode layer 23 of the second panel 2 may include a plurality of third electrodes 231 extending along one direction (for example, the X direction), and the fourth electrode layer 25 of the second panel 2 may include a plurality of fourth electrodes 251 extending along another direction (for example, the Y direction). In the top-view direction Z, the plurality of third electrodes 231 and the plurality of fourth electrodes 251 are, for example, intersected with each other, and an overlapping area where the third electrode 231 and the fourth electrode 251 are intersected with each other may be defined as a pixel area P, wherein the first color filter layer CF1 may, for example, be disposed between the fourth substrate 27 and the fourth electrode layer 25 and is disposed corresponding to the pixel area P, and the second spacer PS2 is disposed corresponding to a non-pixel area NP, that is, in the top-view direction Z, the first color filter layer CF1 overlaps with the pixel area P, and the second spacer PS2 overlaps with the non-pixel area NP. In one embodiment of the present disclosure, the reflective panel RP includes a plurality of pixel areas P and a non-pixel area NP. In the top-view direction Z, the first opening H1′ of the first color filter layer CF1 overlaps with the non-pixel area NP.

In one embodiment of the present disclosure, the partial enlarged view of FIG. 2A may be shown, for example, in FIG. 2D. In more detail, the partial enlarged view of the third panel 3 of the reflective panel RP may be shown, for example, in FIG. 2D, wherein the upper half of FIG. 2D is a top view schematic diagram, and the lower half is a schematic cross-sectional view taken along line C-C′ of the upper half. The fifth electrode layer 33 of the third panel 3 may include a plurality of fifth electrodes 331 extending along one direction (for example, the X direction), and the sixth electrode layer 35 of the third panel 3 may include a plurality of sixth electrodes 351 extending along another direction (for example, the Y direction). In the top-view direction Z, the plurality of fifth electrodes 331 and the plurality of sixth electrodes 351 are, for example, intersected with each other, and an overlapping area where the fifth electrode 331 and the sixth electrode 351 are intersected with each other may be defined as a pixel area P, wherein the second color filter layer CF2 is disposed between the sixth substrate 37 and the sixth electrode layer 35 and is disposed corresponding to the pixel area P, and the third spacer PS3 is disposed corresponding to the non-pixel area NP, that is, in the top-view direction Z, the second color filter layer CF2 overlaps with the pixel area P, and the third spacer PS3 overlaps with the non-pixel area NP. In one embodiment of the present disclosure, in the top-view direction Z, the second opening H2′ of the second color filter layer CF2 overlaps with the non-pixel area NP. In other embodiments (not shown), when the first panel 1 includes a color filter layer (not shown), in the top-view direction Z, the opening (not shown) of the color filter layer overlaps with the non-pixel area NP of the first panel 1.

In the present disclosure, other detailed features of the reflective panel RP may be as described in FIG. 1B and will not be repeated here. In addition, other components and materials of the electronic device may also be as described above and will not be described in detail herein.

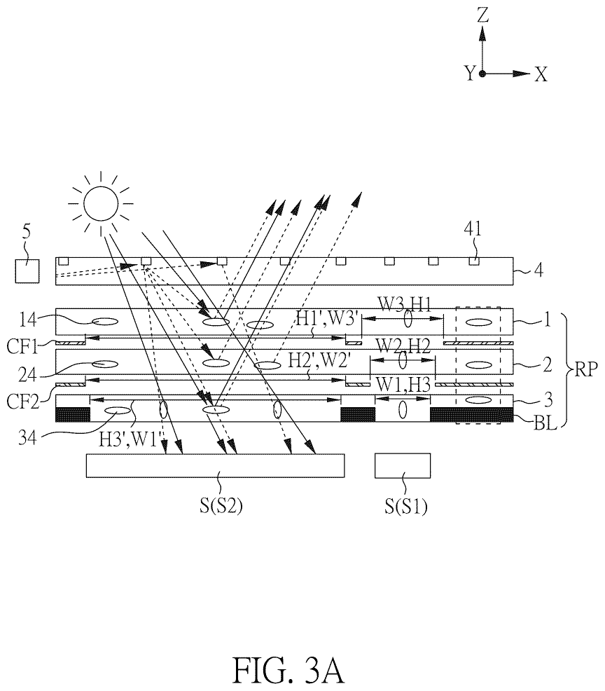

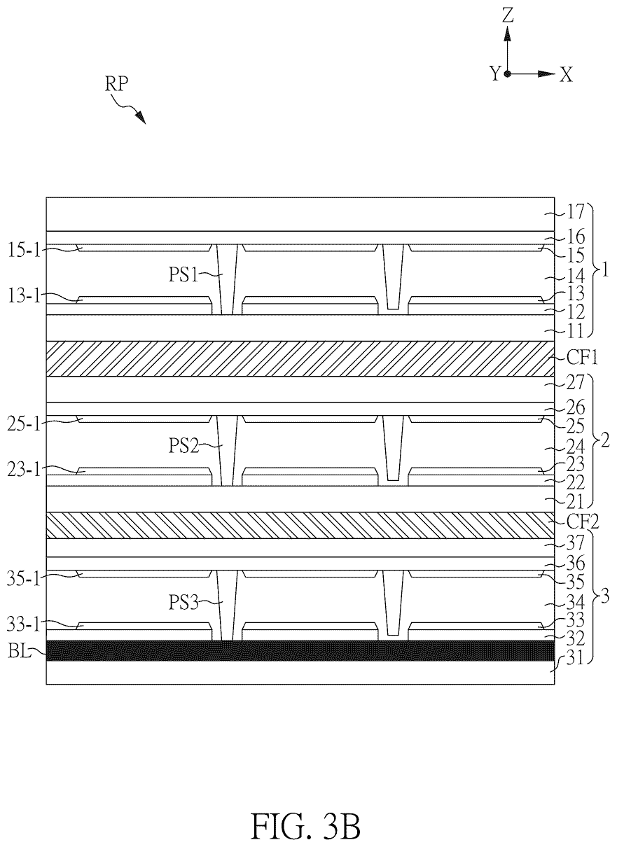

FIG. 3A is a schematic cross-sectional view of an electronic device according to an embodiment of the present disclosure, and FIG. 3B is a partial enlarged view of FIG. 3A, wherein the electronic device of FIG. 3A is similar to that of FIG. 1A, except for the following differences. In addition, some components are omitted in the figures for convenience of explanation.

In one embodiment of the present disclosure, as shown in FIG. 3A and FIG. 3B, the first color filter layer CF1 is disposed between the first panel 1 and the second panel 2, and/or the second color filter layer CF2 is disposed between the second panel 2 and the third panel 3. The first panel 1 and the second panel 2 may be fixed to each other through the first color filter layer CF1, and the second panel 2 and the third panel 3 may be fixed to each other through the second color filter layer CF2, that is, the first color filter layer CF1 and/or the second color filter layer CF2 may have adhesiveness. In addition, the third panel 3 may include a light absorbing layer BL. The light absorbing layer BL is disposed between the fifth substrate 31 and the third cholesteric liquid crystal 34, for example, but not limited thereto. In the top-view direction Z, the optical sensing element S overlaps with the first opening H1 of the first color filter layer CF1, the second opening H2 of the second color filter layer CF2, and/or the third opening H3 of the light absorbing layer BL. When the electronic device includes a plurality of optical sensing elements S, the first color filter layer CF1 may include a plurality of first openings (for example, first openings H1 and H1′), the second color filter layer CF2 may include a plurality of second openings (for example, second openings H2 and H2′), and the light absorbing layer BL may include a plurality of third openings (for example, third openings H3 and H3′), wherein the plurality of optical sensing elements S may respectively overlap with the first openings H1 and H1′ of the first color filter layer CF1, the second openings H2 and H2′ of the second color filter layer CF2 and/or the third openings H3 and H3′ of the light absorbing layer BL.

In one embodiment of the present disclosure, the width W1 of the third opening H3 may be smaller than or equal to the width W2 of the second opening H2, and the width W2 of the second opening H2 may be smaller than or equal to the width W3 of the first opening H1, which may reduce the alignment error or improve the process yield. In one embodiment of the present disclosure, the width W1′ of the third opening H3′ may be smaller than or equal to the width W2′ of the second opening H2′, and the width W2′ of the second opening H2′ may be smaller than or equal to the width W3′ of the first opening H1′, which may reduce the assembly error or improve the process yield.

In the present disclosure, other detailed features of the reflective panel RP may be referred to as shown in FIG. 1B and will not be described in detail here. In addition, other components and materials of the electronic device may be as described above and will not be described in detail herein.

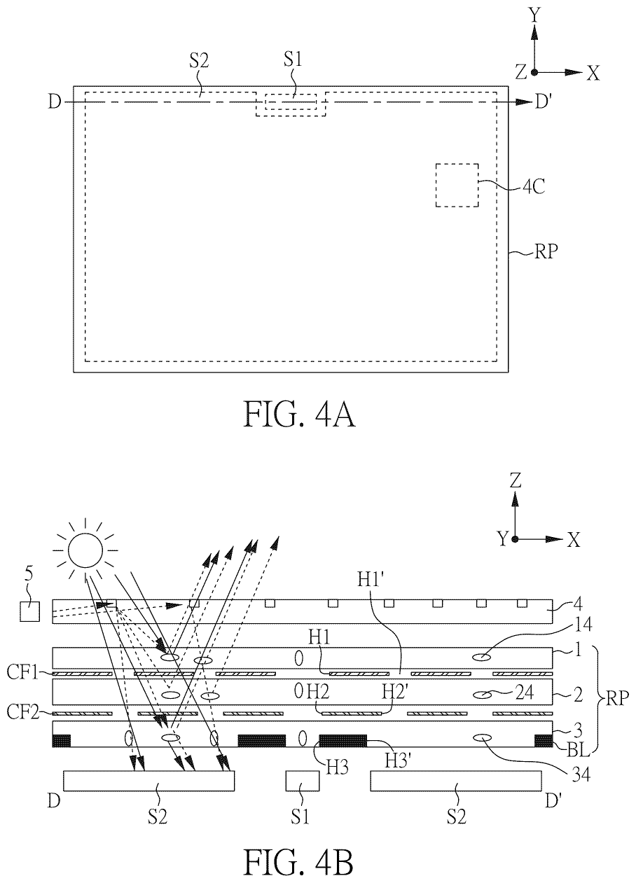

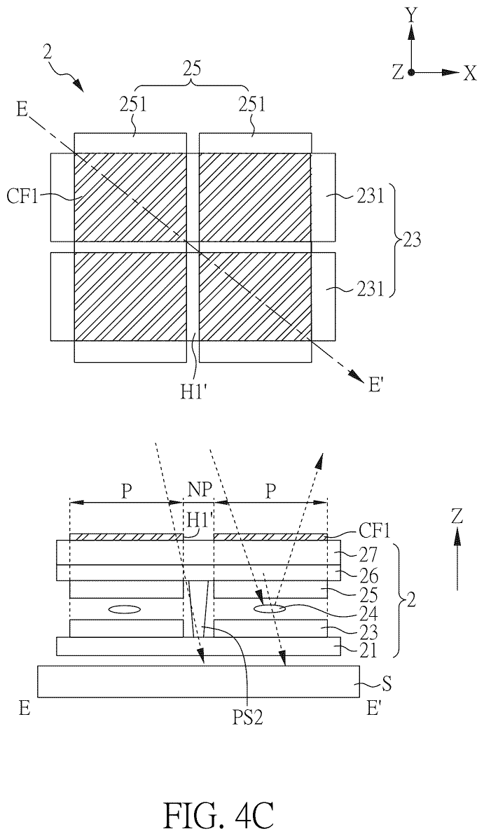

FIG. 4A is a schematic top view of an electronic device according to an embodiment of the present disclosure. FIG. 4B is a schematic cross-sectional view of the electronic device taken along line D-D′ of FIG. 4A. FIG. 4C is a partial enlarged view of FIG. 4A. The electronic device shown in FIG. 4B is similar to that shown in FIG. 3A, except for the following differences. In addition, some components are omitted in the figure for convenience of explanation.

In one embodiment of the present disclosure, as shown in FIG. 4A and FIG. 4B, the electronic device may include a plurality of optical sensing elements S1 and S2 disposed under the reflective panel RP, wherein the optical sensing element S2 may surround a plurality of sides of the optical sensing element S1, but it is not limited thereto. In one embodiment of the present disclosure, the optical sensing element S1 may be, for example, a camera lens, and the optical sensing element S2 may be, for example, a photoelectric conversion element, but it is not limited thereto. In the top-view direction Z, the first color filter layer CF1 and/or the second color filter layer CF2 may not overlap with the optical sensing element S1, thereby improving the image quality. When the area or width of the optical sensing element S2 is designed to be greater (for example, greater than 20 mm, but not limited thereto), in the top-view direction Z, part of the first color filter layer CF1 may, for example, at least partially overlap with the optical sensing element S2, and part of the second color filter layer CF2 may, for example, at least partially overlap with the optical sensing element S2, thereby maintaining the display quality and improving the light conversion efficiency. In more detail, part of the ambient light and the light provided by the light source may pass through the first color filter layer CF1 and the second color filter layer CF2 respectively for being reflected by the cholesteric liquid crystal, thereby improving the color purity or brilliance displayed by the electronic device, and part of the ambient light and the light provided by the light source may pass through the first opening H1′ of the first color filter layer CF1 and the second opening H2′ of the second color filter layer CF2 respectively, so that part of the light may pass through the reflective panel RP to the optical sensing element S2 (for example, a photoelectric conversion element) for being converted into electrical energy.

In one embodiment of the present disclosure, the partial enlarged view of FIG. 4A may be shown, for example, in FIG. 4C. In more detail, the partial enlarged view of the second panel 2 of the reflective panel RP may be shown, for example, in FIG. 4C, wherein the upper half of FG. 4C is a top view schematic diagram, and the lower half is a schematic cross-sectional view taken along line E-E′ of the upper half. The third electrode layer 23 of the second panel 2 may include a plurality of third electrodes 231 extending along one direction (for example, the X direction), and the fourth electrode layer 25 of the second panel 2 may include a plurality of fourth electrodes 251 extending along another direction (for example, the Y direction). In the top-view direction Z, the plurality of third electrodes 231 and the plurality of fourth electrodes 251 are intersected with each other, and an overlapping area where the third electrode 231 and the fourth electrode 251 are intersected with each other may be defined as a pixel area P, wherein the first color filter layer CF1 is disposed on the fourth substrate 27 and is disposed corresponding to the pixel area P, and the second spacer SP2 is disposed corresponding to the non-pixel area NP, that is, in the top-view direction Z, the first color filter layer CF1 overlaps with the pixel area P, and the first opening H1′ of the first color filter layer CF1 overlaps with the non-pixel area NP.

In one embodiment of the present disclosure, although not shown in the figures, with reference to the disclosure of FIG. 2D, the fifth electrode layer 33 of the third panel 3 of the reflective panel RP may also include a plurality of fifth electrodes 331 extending along one direction (for example, the X direction), and the sixth electrode layer 35 of the third panel 3 may also include a plurality of sixth electrodes 351 extending along another direction (for example, the Y direction). In the top-view direction Z, the plurality of fifth electrodes 331 and the plurality of sixth electrodes 351 are intersected with each other, and the overlapping area where the fifth electrode 331 and the sixth electrode 351 are intersected with each other is the pixel area P, wherein the second color filter layer CF2 is disposed on the sixth substrate 37 and is disposed corresponding to the pixel area P, and the third spacer SP3 is disposed corresponding to the non-pixel area NP, that is, in the top-view direction Z, the second color filter layer CF2 overlaps with the pixel area P, and the third spacer SP3 overlaps with the non-pixel area NP. In one embodiment of the present disclosure, in the top-view direction Z, the second opening H2′ of the second color filter layer CF2 overlaps with the non-pixel area NP. In other embodiments (not shown), when the first panel 1 includes a color filter layer (not shown), in the top-view direction Z, the opening (not shown) of the color filter layer overlaps with the non-pixel area NP of the first panel 1.

In the present disclosure, other detailed features of the reflective panel RP may be referred to as shown in FIG. 3B and will not be described in detail here. In addition, other components and materials of the electronic device may be as described above and will not be described in detail herein.

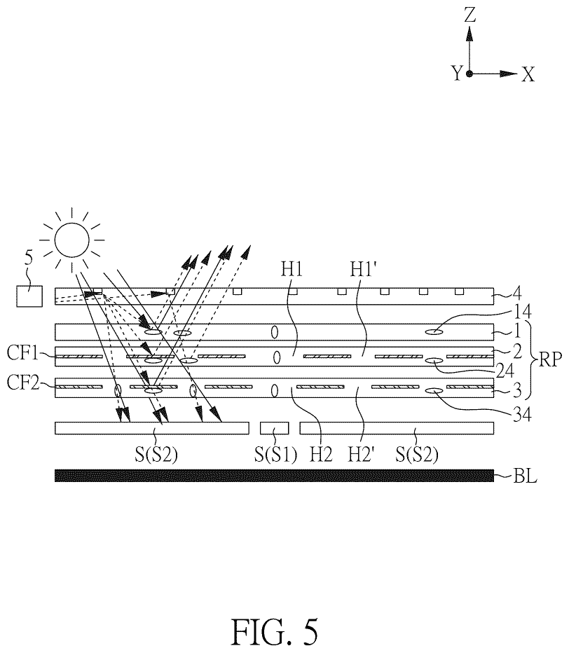

FIG. 5 is a schematic cross-sectional view of an electronic device according to an embodiment of the present disclosure. The electronic device of FIG. 5 is similar to that of FIG. 1A and FIG. 2B, except for the following differences. In addition, some components are omitted in the figure for convenience of explanation.

In one embodiment of the present disclosure, as shown in FIG. 5, the light absorbing layer BL of the electronic device may be disposed under the optical sensing element S. More specifically, the optical sensing element S may be disposed between the reflective panel RP and the light absorbing layer BL. The light absorbing layer BL may be used to absorb light that is not absorbed or reflected by the optical sensing element S, thereby increasing the contrast effect of the displayed image and improving the display quality of the display device.

In one embodiment of the present disclosure, in the top-view direction Z, the light absorbing layer BL may overlap with the optical sensing element S. In one embodiment of the present disclosure, in the top-view direction Z, the light absorbing layer BL may overlap with the first openings H1, H1′ of the first color filter layer CF1 and the second openings H2, H2′ of the second color filter layer CF2, respectively. In one embodiment of the present disclosure, as shown in FIG. 5, the light absorbing layer BL may not include the third openings H3 and H3′ (as shown in FIG. 1A). However, in other embodiments, the light absorbing layer BL may selectively include the third openings H3 and H3′ as needed.

In one embodiment of the present disclosure, as shown in FIG. 5, the optical sensing element S1 may be, for example, a camera lens, and the optical sensing element S2 may be, for example, a photoelectric conversion element. In the top-view direction Z, part of the first color filter layer CF1 may overlap with the optical sensing element S2, and part of the second color filter layer CF2 may overlap with the optical sensing element S2, thereby maintaining display quality and improving light conversion efficiency.

In the present disclosure, other detailed features of the reflective panel RP may be referred to as shown in FIG. 1B, FIG. 2C and FIG. 2D, and will not be described in detail here. In addition, other components and materials of the electronic device may be as described above and will not be described in detail herein.

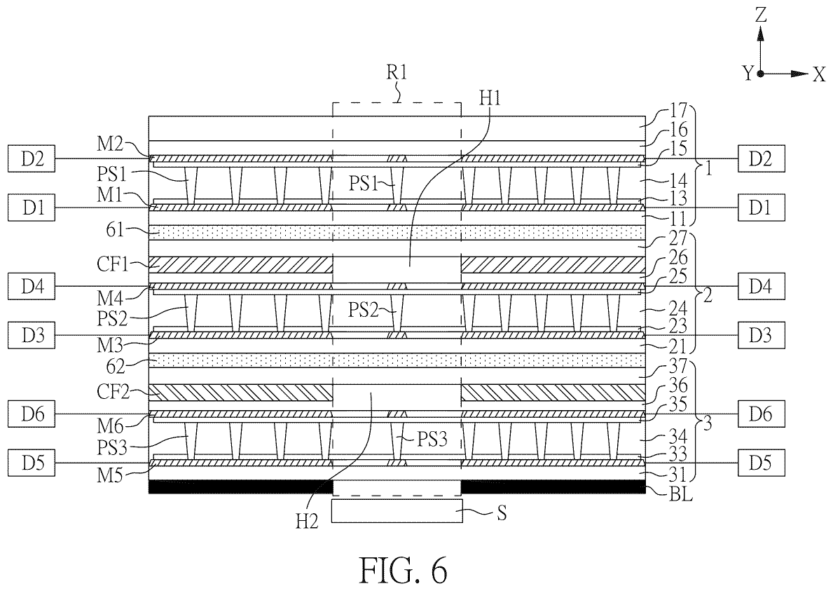

FIG. 6 is a schematic cross-sectional view of an electronic device according to an embodiment of the present disclosure. The electronic device of FIG. 6 is similar to that of FIG. 1A and FIG. 1B, except for the following differences. In addition, some components are omitted in the figure for convenience of explanation.

In one embodiment of the present disclosure, as shown in FIG. 6, the three sub-panels (for example, the first panel 1, the second panel 2 and the third panel 3) of the reflective panel RP may each include a metal layer. In more detail, the first panel 1 may include: a first metal layer M1 arranged between the first substrate 11 and the first electrode layer 13; and a second metal layer M2 arranged between the second substrate 17 and the second electrode layer 15, wherein the first metal layer M1 may be electrically connected to the first electrode layer 13 and the driver D1 respectively, and the second metal layer M2 may be electrically connected to the second electrode layer 15 and the driver D2 respectively, so as to transmit signals from the drivers D1 and D2 to the first electrode layer 13 and the second electrode layer 15 via the first metal layer M1 and the second metal layer M2 respectively, thereby controlling the first cholesteric liquid crystal 14 to display image. It should be noted that an insulating layer (not shown) may be interposed between the first metal layer M1 and the first electrode layer 13, and the first metal layer M1 and the first electrode layer 13 are electrically connected via a through hole (not shown) of the insulating layer (not shown). It should be noted that an insulating layer (not shown) may be interposed between the second metal layer M2 and the second electrode layer 15, and the second metal layer M2 and the second electrode layer 15 are electrically connected via a through hole (not shown) of the insulating layer (not shown). The second panel 2 includes: a third metal layer M3 arranged between the third substrate 21 and the third electrode layer 23; and a fourth metal layer M4 arranged between the fourth substrate 27 and the fourth electrode layer 25, wherein the third metal layer M3 may be electrically connected to the third electrode layer 23 and the driver D3 respectively, and the fourth metal layer M4 may be electrically connected to the fourth electrode layer 25 and the driver D4 respectively, so as to transmit signals from the drivers D3, D4 to the third electrode layer 23 and the fourth electrode layer 25 respectively via the third metal layer M3 and the fourth metal layer M4, thereby controlling the second cholesteric liquid crystal 24 to display image. It should be noted that an insulating layer (not shown) may be interposed between the third metal layer M3 and the third electrode layer 23, and the third metal layer M3 and the third electrode layer 23 are electrically connected via a through hole (not shown) of the insulating layer (not shown). It should be noted that an insulating layer (not shown) may be interposed between the fourth metal layer M4 and the fourth electrode layer 25, and the fourth metal layer M4 and the fourth electrode layer 25 are electrically connected via a through hole (not shown) of the insulating layer (not shown). The third panel 3 includes: a fifth metal layer M5 arranged between the fifth substrate 31 and the fifth electrode layer 33; and a sixth metal layer M6 arranged between the sixth substrate 37 and the sixth electrode layer 35, wherein the fifth metal layer M5 may be electrically connected to the fifth electrode layer 33 and the driver D5 respectively, and the sixth metal layer M6 may be electrically connected to the sixth electrode layer 35 and the driver D6 respectively, so as to transmit signals from the drivers D5, D6 to the fifth electrode layer 33 and the sixth electrode layer 35 respectively via the fifth metal layer M5 and the sixth metal layer M6, thereby controlling the third cholesteric liquid crystal 34 to display image. It should be noted that an insulating layer (not shown) may be interposed between the fifth metal layer M5 and the fifth electrode layer 33, and the fifth metal layer M5 and the fifth electrode layer 33 are electrically connected via a through hole (not shown) of the insulating layer (not shown). It should be noted that an insulating layer (not shown) may be interposed between the sixth metal layer M6 and the sixth electrode layer 35, and the sixth metal layer M6 and the sixth electrode layer 35 are electrically connected via a through hole (not shown) of the insulating layer (not shown).

The uniformity of signal transmission may be improved by providing the first metal layer M1, the second metal layer M2, the third metal layer M3, the fourth metal layer M4, the fifth metal layer M5 and/or the sixth metal layer M6.

In one embodiment of the present disclosure, as shown in FIG. 6, the electronic device may selectively include at least one driver D1, D2, D3, D4, D5 and D6, or a plurality of drivers D1, D2, D3, D4, D5 and D6, which are respectively electrically connected to the first metal layer M1, the second metal layer M2, the third metal layer M3, the fourth metal layer M4, the fifth metal layer M5 and/or the sixth metal layer M6. When the electronic device includes a plurality of drivers D1, D2, D3, D4, D5 and D6, these drivers may be disposed at different sides to provide signals through different sides, thereby transmitting the signals to corresponding metal layers. By providing a plurality of drivers (for example, D1 to D6), the impedance may be reduced. In one embodiment of the present disclosure, at the same unit area, the area of a portion of the metal layer (for example, the first metal layer M1, the second metal layer M2, the third metal layer M3, the fourth metal layer M4, the fifth metal layer M5 and/or the sixth metal layer M6) overlapping with the optical sensing element S is smaller than the area of another portion of the metal layer (for example, the first metal layer M1, the second metal layer M2, the third metal layer M3, the fourth metal layer M4, the fifth metal layer M5 and/or the sixth metal layer M6) not overlapping with the optical sensing element S. In other words, at the same unit area, the area of a portion of the metal layer (for example, the first metal layer M1, the second metal layer M2, the third metal layer M3, the fourth metal layer M4, the fifth metal layer M5 and/or the sixth metal layer M6) disposed in the optical sensing element area R1 is smaller than the area of another portion of the metal layer (for example, the first metal layer M1, the second metal layer M2, the third metal layer M3, the fourth metal layer M4, the fifth metal layer M5 and/or the sixth metal layer M6) disposed in the non-optical sensing element area (for example, the area outside the optical sensing element area R1). In this way, the influence of the metal layers (for example, the first metal layer M1, the second metal layer M2, the third metal layer M3, the fourth metal layer M4, the fifth metal layer M5 and/or the sixth metal layer M6) on the optical sensing element S may be reduced.

In one embodiment of the present disclosure, as shown in FIG. 6, the three sub-panels of the reflective panel (for example, the first panel 1, the second panel 2 and the third panel 3) may each include a plurality of spacers (for example, the first spacer PS1, the second spacer PS2 and the third spacer PS3), wherein, at the same unit area, the density of a portion of the spacers (for example, the first spacer PS1, the second spacer PS2 and the third spacer PS3) overlapping with the optical sensing element S is smaller than the density of another portion of the spacers (for example, the first spacer PS1, the second spacer PS2 and the third spacer PS3) not overlapping with the optical sensing element S. In other words, at the same unit area, the density of a portion of the spacers (for example, the first spacer PS1, the second spacer PS2 and the third spacer PS3) disposed in the optical sensing element area R1 is smaller than the density of another portion of the spacers (for example, the first spacer PS1, the second spacer PS2 and the third spacer PS3) disposed in the non-optical sensing element area (for example, the area outside the optical sensing element area R1). In this way, the influence of the spacers on the optical sensing element S may be reduced.

In the present disclosure, the optical sensing element S may include, for example, a camera lens, a photoelectric conversion element, a biometric sensing element, or a combination thereof, but the present disclosure is not limited thereto. In the present disclosure, the first metal layer M1, the second metal layer M2, the third metal layer M3, the fourth metal layer M4, the fifth metal layer M5 and the sixth metal layer M6 may each include a single-layer structure or a multi-layer structure, and may each include a suitable metal material, for example, gold, silver, copper, palladium, platinum, ruthenium, aluminum, cobalt, nickel, titanium, molybdenum, manganese, tungsten, alloys thereof or a combination thereof, but the present disclosure is not limited thereto. In the present disclosure, other detailed features of the reflective panel RP may be referred to as shown in FIG. 1B, which will not be described in detail here. In addition, other components and materials of the electronic device may be as described above and will not be described in detail herein.

In addition, in other embodiments, although not shown in the figures, the three sub-panels of the reflective panel RP shown in FIG. 3A and FIG. 3B or other figures may also selectively include a plurality of metal layers and a plurality of spacers as shown in FIG. 6, which will not be repeated here.

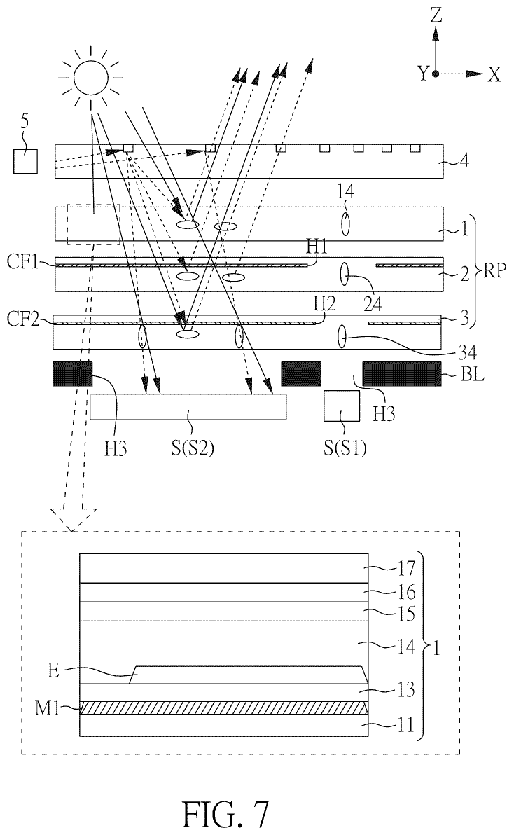

FIG. 7 is a schematic cross-sectional view of an electronic device according to an embodiment of the present disclosure. The electronic device of FIG. 7 is similar to that of FIG. 1A, except for the following differences. In addition, some components are omitted in the figure for convenience of explanation.

In one embodiment of the present disclosure, as shown in FIG. 7, the electronic device may include a photoelectric conversion element E disposed in the reflective panel RP. In more detail, the first panel 1 may include: a first metal layer M1 disposed between the first substrate 11 and the first electrode layer 13; and a photoelectric conversion element E disposed on the first electrode layer 13 and overlapping the first metal layer M1. In this way, the light conversion efficiency may be improved. In one embodiment of the present disclosure, the photoelectric conversion element E may be disposed in a non-display area of the electronic device, so as to improve the light conversion efficiency without increasing the aperture ratio. In the present disclosure, the photoelectric conversion element E may include a solar cell, such as a perovskite solar cell, a dye-sensitized solar cell or a combination thereof, but the present disclosure is not limited thereto. The perovskite solar cell may, for example, include a perovskite solar cell with an n-i-p structure or a perovskite solar cell with a p-i-n structure, but the present disclosure is not limited thereto.

In the present disclosure, other detailed features of the reflective panel RP may be referred to as shown in FIG. 1B and will not be described in detail here. In other embodiments, although not shown in the figures, other detailed features of the reflective panel RP may also be referred to as shown in FIGS. 3A and 3B, that is, the first color filter layer CF1 may be disposed between the first panel 1 and the second panel 2, and the second color filter layer CF2 may be disposed between the second panel 2 and the third panel 3. In addition, other components and materials of the electronic device may be as described above and will not be described in detail herein.

FIG. 8 is a schematic cross-sectional view of an electronic device according to an embodiment of the present disclosure. The electronic device of FIG. 8 is similar to that of FIG. 1A, except for the following differences. In addition, some components are omitted in the figure for convenience of explanation.

In one embodiment of the present disclosure, as shown in FIG. 8, the light guide plate 4 includes a light emitting surface 4s1, and a first light incident surface 4s2 and a second light incident surface 4s3 connected to the light emitting surface 4s1, wherein the first light incident surface 4s2 and the second light incident surface 4s3 are arranged opposite to each other. The light source 5 of the electronic device is disposed adjacent to the first light incident surface 4s2 and the second light incident surface 4s3 respectively, which may improve the brightness uniformity of the light source and the display quality of the electronic device. In addition, when the optical sensing element S is, for example, a biometric sensing element, the sensing effect of the biometric sensing element may be enhanced, but the present disclosure is not limited thereto.

In the present disclosure, other detailed features of the reflective panel RP may be referred to as shown in FIG. 1B and will not be described in detail here. In other embodiments, although not shown in the figures, other detailed features of the reflective panel RP may also be referred to as shown in FIG. 3A and FIG. 3B, that is, the first color filter layer CF1 may be disposed between the first panel 1 and the second panel 2, and the second color filter layer CF2 may be disposed between the second panel 2 and the third panel 3. In addition, other components and materials of the electronic device may be as described above and will not be described in detail herein.

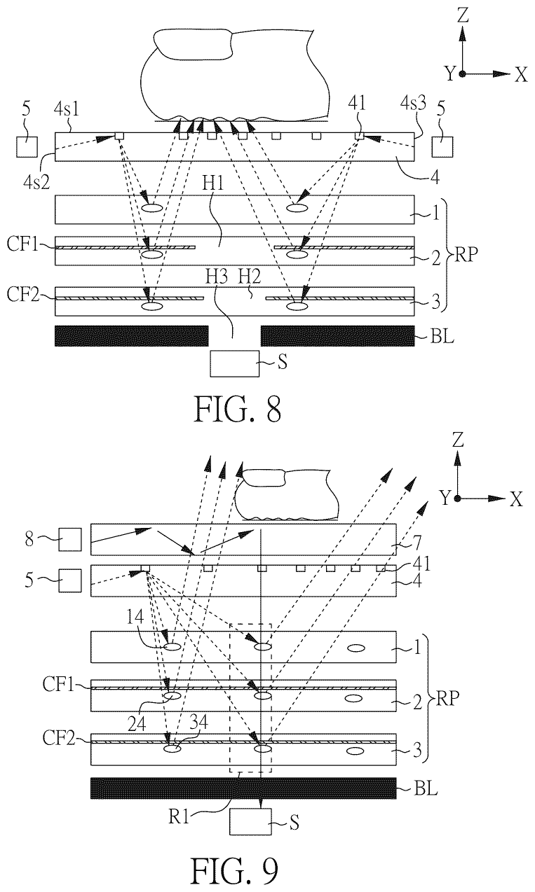

FIG. 9 is a schematic cross-sectional view of an electronic device according to an embodiment of the present disclosure.

In one embodiment of the present disclosure, as shown in FIG. 9, the electronic device may include a reflective panel RP; an optical sensing element S disposed under the reflective panel RP; and a light absorbing layer BL disposed between the reflective panel RP and the optical sensing element S. The light absorbing layer BL overlaps with the optical sensing element S in a top-view direction.

In the present disclosure, the reflective panel RP may include: a first cholesteric liquid crystal 14 for reflecting light of first color; a second cholesteric liquid crystal 24 arranged under the first cholesteric liquid crystal 14, wherein the second cholesteric liquid crystal 24 is used to reflect light of second color; a third cholesteric liquid crystal 34 arranged under the second cholesteric liquid crystal 24, wherein the third cholesteric liquid crystal 34 is used to reflect light of third color; a first color filter layer CF1 arranged between the first cholesteric liquid crystal 14 and the second cholesteric liquid crystal 24; and a second color filter layer CF2 arranged between the second cholesteric liquid crystal 24 and the third cholesteric liquid crystal 34. In more detail, the reflective panel RP may include: a first panel 1 including a first cholesteric liquid crystal 14; a second panel 2 arranged under the first panel 1 and including a second cholesteric liquid crystal 24 and a first color filter layer CF1; and a third panel 3 arranged under the second panel 2 and including a third cholesteric liquid crystal 34 and a second color filter layer CF2.

In the present disclosure, the reflective panel RP shown in FIG. 9 is similar to that of FIG. 1A and FIG. 1B, except for the following differences. As shown in FIG. 9, the first color filter layer CF1 may not include the first openings H1 and H1′ (as shown in FIG. 1A), and the second color filter layer CF2 may not include the second openings H2 and H2′ (as shown in FIG. 1A). In other words, in the top-view direction Z, at least one of the first color filter layer CF1 and the second color filter layer CF2 overlaps with the optical sensing element S. In addition, in other embodiments, although not shown in the figures, the reflective panel RP may also be similar to that of FIG. 3A and FIG. 3B, that is, the first color filter layer CF1 may be disposed between the first panel 1 and the second panel 2, and the second color filter layer CF2 may be disposed between the second panel 2 and the third panel 3. In addition, other detailed features of the reflective panel RP may be referred to the above description and will not be repeated here.

In the present disclosure, the optical sensing element S may include a biometric sensing element, such as a fingerprint sensor, an infrared sensor, other suitable sensors, or a combination thereof, but it is not limited thereto. Therefore, the electronic device of the present disclosure may be an electronic device for detecting biological characteristics. In the present disclosure, the light absorbing layer BL may not include the third openings H3 and H3′ (as shown in FIG. 1A). In other words, in the top-view direction Z, the light absorbing layer BL and the optical sensing element S overlap. In one embodiment of the present disclosure, in the top-view direction, the light absorbing layer BL may overlap with the optical sensing device area R1.

In one embodiment of the present disclosure, as shown in FIG. 9, the electronic device may include a light guide plate 4 disposed on the reflective panel RP; a light source 5 disposed adjacent to the light guide plate 4; a cover substrate 7 disposed on the light guide plate 4; and another light source 8 disposed adjacent to the cover substrate 7. When the electronic device is in a dark environment, the light source 5 may provide additional light and guide the emitted light downward to the reflective panel RP through the light guide plate 4 for use, thereby improving the display quality of the electronic device. The light source 8 may provide light of first wavelength, which is transmitted through the cover substrate 7. When an object to be detected (such as a finger) approaches the electronic device, the light of first wavelength is reflected back to the optical sensing element S. The optical sensing element S may be used to sense the light of first wavelength to detect biological characteristics.

In the present disclosure, the wavelength of the light of first wavelength may be smaller than or equal to 360 nm, or greater than or equal to 830 nm. For example, the wavelength of the light of first wavelength may be greater than or equal to 830 nm and smaller than or equal to 3000 nm (830 nm≤wavelength≤3000 nm), or the wavelength of the light of first wavelength may be greater than or equal to 10 nm and smaller than or equal to 360 nm (10 nm≤wavelength≤360 nm), but the present disclosure is not limited thereto. In the present disclosure, the transmittance of the light absorbing layer BL to the light of first wavelength may be greater than or equal to 50%, for example, greater than or equal to 60%, greater than or equal to 65%, greater than or equal to 70%, greater than or equal to 75%, or greater than or equal to 80%, but the present disclosure is not limited thereto. Therefore, part of the light of first wavelength may pass through the light absorbing layer BL to the optical sensing element S, so that the optical sensing element S may achieve the effect of detecting biological characteristics.

In the present disclosure, the components and materials of the electronic device may be as described above and will not be repeated here. In the present disclosure, the cover substrate 7 may include an inflexible substrate, a flexible substrate or a film, and suitable materials may include glass, quartz, sapphire, ceramic, plastic, polycarbonate (PC), polyimide (PI), polypropylene (PP), polyethylene terephthalate (PET), polymethylmethacrylate (PMMA), other suitable materials or a combination thereof, but the present disclosure is not limited thereto.

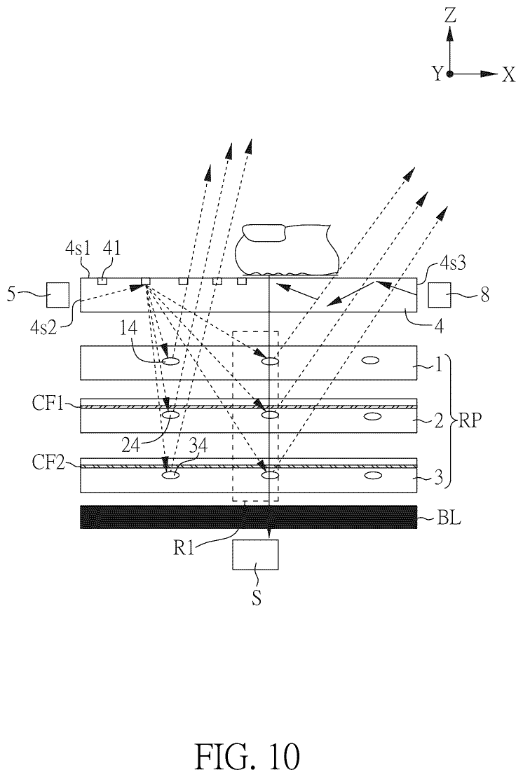

FIG. 10 is a schematic cross-sectional view of an electronic device according to an embodiment of the present disclosure. The electronic device of FIG. 10 is similar to that of FIG. 9, except for the following differences. In addition, some components are omitted in the figure for convenience of explanation.

In one embodiment of the present disclosure, as shown in FIG. 10, the light guide plate 4 includes a light emitting surface 4s1, and a first light incident surface 4s2 and a second light incident surface 4s3 connected to the light emitting surface 4s1, wherein the first light incident surface 4s2 and the second light incident surface 4s3 are arranged opposite to each other. The light source 5 is disposed adjacent to the first light incident surface 4s2, and another light source 8 is disposed adjacent to the second light incident surface 4s3. The light source 5 and the light source 8 may share the light guide plate 4 for light transmission, and thus, the cover substrate 7 (as shown in FIG. 9) may be omitted, thereby obtaining a thin electronic device. When the electronic device is in a dark environment, the light source 5 may provide additional light and guide the emitted light downward to the reflective panel RP through the light guide plate 4 for use, thereby improving the display quality of the electronic device. The light source 8 may provide light of first wavelength, which is transmitted through the light guide plate 4. When an object to be detected (such as a finger) approaches the electronic device, the light of first wavelength is reflected back to the optical sensing element S. The optical sensing element S may be used to sense the light of first wavelength to detect biological characteristics.

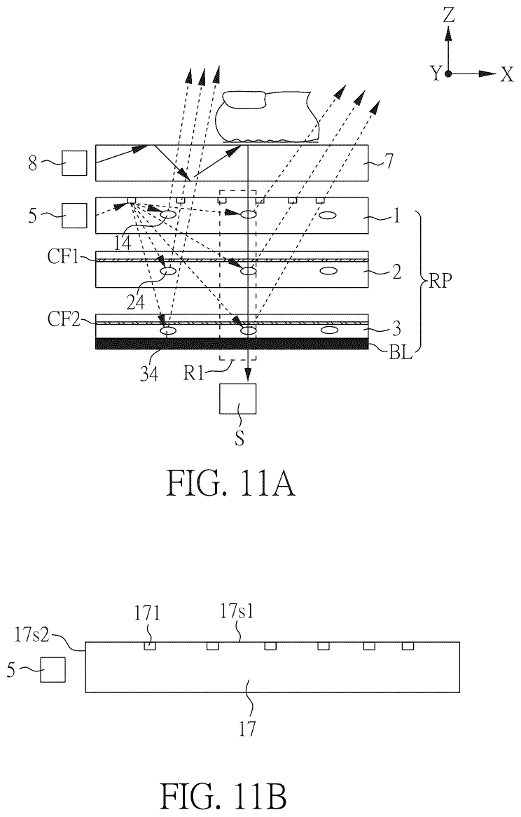

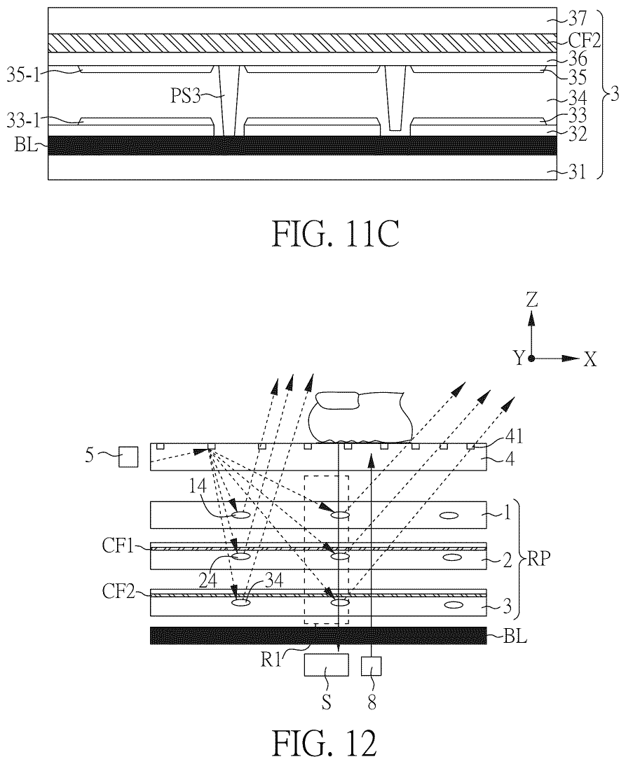

FIG. 11A is a schematic cross-sectional view of an electronic device according to an embodiment of the present disclosure. FIG. 11B is a partial enlarged view of the first panel. FIG. 11C is a partial enlarged view of FIG. 11A. The electronic device of FIG. 11A is similar to that of FIG. 9, except for the following differences. For the convenience of explanation, some components are omitted in the figure.

In one embodiment of the present disclosure, as shown in FIG. 11A and FIG. 11B, the light source 5 may be disposed adjacent to the first panel 1. In more detail, the second substrate 17 of the first panel 1 may include an upper surface 17s1 and a side surface 17s2 connected to the upper surface 17s1, and the light source 5 may be disposed adjacent to the side surface 17s2 of the second substrate 17. The light provided by the light source 5 may be guided downward to the reflective panel RP through the second substrate 17 for use. Therefore, the electronic device may selectively omit the light guide plate 4 (as shown in FIG. 9), thereby making the electronic device thinner or saving costs. In the present disclosure, the upper surface 17s1 of the second substrate 17 may be provided with a plurality of microstructures 171, and the microstructures 171 may be used to improve the utilization rate of light. The microstructure 171 may include a concave structure, a convex structure or a combination thereof. Alternatively, the microstructure 171 may include a dot microstructure. At the same unit area, the density of the microstructures 171 near the light source 5 may be smaller than the density of the microstructures 171 far from the light source 5.

In one embodiment of the present disclosure, as shown in FIG. 11A and FIG. 11C, the third panel 3 may include a light absorbing layer BL disposed between the fifth substrate 31 and the third cholesteric liquid crystal 34. The light absorbing layer BL may be used to absorb most of the light that is not reflected by the first cholesteric liquid crystal 14, the second cholesteric liquid crystal 24 and the third cholesteric liquid crystal 34, thereby improving the display quality of the electronic device.

In the present disclosure, other detailed features of the reflective panel RP may be referred to as shown in FIG. 1B and will not be described in detail here. In other embodiments, although not shown in FIG. 8, FIG. 9, FIG. 10 and FIG. 11A, the first color filter layer CF1 of these reflective panels RP may be disposed between the first panel 1 and the second panel 2, and/or the second color filter layer CF2 may be disposed between the second panel 2 and the third panel 3. In addition, other components and materials of the electronic device may be as described above and will not be described in detail herein.

FIG. 12 is a schematic cross-sectional view of an electronic device according to an embodiment of the present disclosure. The electronic device of FIG. 12 is similar to that of FIG. 9, except for the following differences. In addition, some components are omitted in the figure for convenience of explanation.

In one embodiment of the present disclosure, as shown in FIG. 12, another light source 8 may be disposed under the reflective panel RP. In one embodiment of the present disclosure, another light source 8 and the optical sensing element S may be disposed under the light absorbing layer BL, and another light source 8 may be disposed adjacent to the optical sensing element S, but it is not limited thereto. The light source 8 may provide light of first wavelength, which may sequentially pass through the light absorbing layer BL, the reflective panel RP and/or the light guide plate 4. When an object to be detected (such as a finger) approaches the electronic device, the light of first wavelength is reflected back to the optical sensing element S, and the optical sensing element S may be used to sense the light of first wavelength, thereby detecting biological characteristics. In this way, the cover substrate 7 (as shown in FIG. 9) may be omitted, thereby obtaining a thinner electronic device.

In the present disclosure, other detailed features of the reflective panel RP may be referred to as shown in FIG. 1B and will not be described in detail here. In other embodiments, although not shown in FIG. 12, the first color filter layer CF1 may be disposed between the first panel 1 and the second panel 2, and/or the second color filter layer CF2 may be disposed between the second panel 2 and the third panel 3. In addition, other components and materials of the electronic device may be as described above and will not be described in detail herein.

The aforementioned specific embodiments should be construed as merely illustrative, and not limiting the rest of the present disclosure in any way.

1. An electronic device, comprising:
a reflective panel including:
a first cholesteric liquid crystal for reflecting light of first color; and
a first color filter layer disposed under the first cholesteric liquid crystal,
wherein the first color filter layer includes a first opening; and
an optical sensing element disposed under the reflective panel,
wherein, in a top-view direction, the optical sensing element overlaps with the first opening of the first color filter layer.

2. The electronic device as claimed in claim 1, wherein the reflective panel further includes:
a second cholesteric liquid crystal disposed under the first color filter layer,
wherein the second cholesteric liquid crystal is provided to reflect light of second color;
a second color filter layer disposed under the second cholesteric liquid crystal, wherein the second color filter layer includes a second opening; and
a third cholesteric liquid crystal disposed under the second color filter layer, wherein the third cholesteric liquid crystal is provided to reflect light of third color,
wherein, in the top-view direction, the optical sensing element overlaps with the second opening of the second color filter layer.

3. The electronic device as claimed in claim 2, further comprising a light absorbing layer disposed between the reflective panel and the optical sensing element and provided with a third opening, wherein, in the top-view direction, the optical sensing element overlaps with the third opening of the light absorbing layer.

4. The electronic device as claimed in claim 3, wherein a width of the third opening is smaller than or equal to a width of the second opening, and the width of the second opening is smaller than or equal to a width of the first opening.

5. The electronic device as claimed in claim 2, wherein the reflective panel includes three sub-panels, the first cholesteric liquid crystal, the second cholesteric liquid crystal and the third cholesteric liquid crystal are respectively disposed in the three sub-panels, and each of the three sub-panels includes a plurality of spacers, in which, at a same unit area, a density of a portion of the spacers overlapping with the optical sensing element is smaller than a density of another portion of the spacers not overlapping with the optical sensing element.

6. The electronic device as claimed in claim 2, wherein the reflective panel includes three sub-panels, the first cholesteric liquid crystal, the second cholesteric liquid crystal and the third cholesteric liquid crystal are respectively disposed in the three sub-panels, and each of the three sub-panels includes a metal layer, in which, at a same unit area, an area of a portion of the metal layer overlapping with the optical sensing element is smaller than an area of another portion of the metal layer not overlapping with the optical sensing element.

7. The electronic device as claimed in claim 1, wherein the reflective panel includes a plurality of pixel areas and a non-pixel area and, in the top-view direction, the first opening of the first color filter layer overlaps with the non-pixel area.

8. The electronic device as claimed in claim 6, further comprising a plurality of drivers respectively electrically connected to the metal layers.

9. The electronic device as claimed in claim 1, further comprising a photoelectric conversion element disposed under the reflective panel, wherein the photoelectric conversion element surrounds the optical sensing element.

10. The electronic device as claimed in claim 2, further comprising a light absorbing layer, wherein the optical sensing element is disposed between the reflective panel and the light absorbing layer, the light absorbing layer overlaps with the optical sensing element, and the light absorbing layer overlaps with the first opening and the second opening respectively.

11. The electronic device as claimed in claim 1, further comprising a light guide plate disposed on the reflective panel; and a light source disposed adjacent to at least one side of the light guide plate.

12. The electronic device as claimed in claim 3, wherein a width of the optical sensing element is smaller than or equal to a width of the third opening.

13. The electronic device as claimed in claim 2, wherein the reflective panel includes a first panel including a first substrate and a second substrate disposed therebetween the first cholesteric liquid crystal, a first electrode layer disposed between the first substrate and the first cholesteric liquid crystal, and a second electrode layer disposed between the second substrate and the first cholesteric liquid crystal; a second panel including a third substrate and a fourth substrate disposed therebetween the second cholesteric liquid crystal, a third electrode layer disposed between the third substrate and the second cholesteric liquid crystal, and a fourth electrode layer disposed between the fourth substrate and the second cholesteric liquid crystal; and a third panel including a fifth substrate and a sixth substrate disposed therebetween the third cholesteric liquid crystal, a fifth electrode layer disposed between the fifth substrate and the third cholesteric liquid crystal, and a sixth electrode layer disposed between the sixth substrate and the third cholesteric liquid crystal.

14. The electronic device as claimed in claim 11, wherein the first panel further includes a first metal layer disposed between the first substrate and the first electrode layer; and a photoelectric conversion element disposed on the first electrode layer and overlapping with the first metal layer.

15. An electronic device, comprising:
a reflective panel;
an optical sensing element disposed under the reflective panel; and
a light absorbing layer disposed between the reflective panel and the optical sensing element,
wherein, in a top-view direction, the light absorbing layer overlaps with the optical sensing element,
wherein the optical sensing element is provided to sense light of first wavelength, and a transmittance of the light absorbing layer to the light of first wavelength is greater than or equal to 50%.

16. The electronic device as claimed in claim 15, wherein a wavelength of the light of first wavelength is greater than or equal to 10 nm and smaller than or equal to 360 nm, or greater than or equal to 830 nm and smaller than or equal to 3000 nm.

17. The electronic device as claimed in claim 15, wherein the reflective panel includes:
a first cholesteric liquid crystal for reflecting light of first color;
a second cholesteric liquid crystal disposed under the first cholesteric liquid crystal, wherein the second cholesteric liquid crystal is provided to reflect light of second color;
a third cholesteric liquid crystal disposed under the second cholesteric liquid crystal, wherein the third cholesteric liquid crystal is provided to reflect light of third color;
a first color filter layer disposed between the first cholesteric liquid crystal and the second cholesteric liquid crystal; and
a second color filter layer disposed between the second cholesteric liquid crystal and the third cholesteric liquid crystal;
wherein, in the top-view direction, at least one of the first color filter layer and the second color filter layer overlaps with the optical sensing element.

18. The electronic device as claimed in claim 15, further comprising a light guide plate disposed on the reflective panel; a light source disposed adjacent to the light guide plate; a covering substrate disposed on the light guide plate; and another light source disposed adjacent to the covering substrate for providing the light of first wavelength.

19. The electronic device as claimed in claim 15, further comprising a light guide plate disposed on the reflective panel and provided with a light emitting surface connected thereto a first light incident surface and a second light incident surface disposed opposite to each other; a light source disposed adjacent to the first light incident surface; and another light source disposed adjacent to the second light incident surface for providing the light of first wavelength.

20. The electronic device as claimed in claim 15, further comprising a light guide plate disposed on the reflective panel; a light source disposed adjacent to the light guide plate; and another light source disposed under the reflective panel for providing the light of first wavelength.
